(19) United States
(12) Patent Application Publication
(10) Pub. No.: US 2016/0179399 A1
(43) Pub. Date: Jun. 23, 2016

(54) System and Method for Selecting Blocks for Garbage Collection Based on Block Health

(71) Applicant: SanDisk Technologies Inc., Plano, TX (US)

(72) Inventor: Ashot Melik-Martirosian, San Jose, CA (US)

(73) Assignee: SanDisk Technologies Inc., Plano, TX (US)

(21) Appl. No.: 14/581,551

(22) Filed: Dec. 23, 2014

(51) Int. Cl. G06F 3/06

(52) U.S. Cl. CPC G06F 3/0608; G06F 3/064; G06F 3/0652; G06F 3/0679

(57) ABSTRACT

Systems and methods for garbage collection in a memory device are disclosed. The memory device includes a plurality of blocks that may be filled with data. In the event that the memory device needs to remove invalid data stored in the blocks, the memory device may perform a garbage collection process. To select the blocks for garbage collection, the memory device may examine both the number of invalid pages in the blocks and the health of the blocks (e.g., the program/erase cycles, erase speed, and program speed). Thus, the memory device may select the blocks for garbage collection that have the most invalid pages and are the healthiest. In this manner, the memory device may more evenly wear the blocks in the memory device.

### TECHNICAL FIELD

This application relates generally to managing data in a memory device. More specifically, this application relates to utilizing block health information in determining which blocks in the memory device to select for garbage collection.

### BACKGROUND

Memory may comprise a plurality of memory cells, in which data may be stored. The memory in the memory device may be organized in one of several ways. One way is to organize the memory into a plurality of blocks, with each of the blocks being composed of multiple pages. In turn, each of the pages may be composes of memory cells.

Data is written (or stored) in the memory. For example, the data may be written in predetermined units, such as pages. Likewise, data may be erased from the memory. For example, when erasing data from the memory, the data may only be erased in blocks. At some point, the memory may not have sufficient space (e.g., a sufficient number of empty blocks that do not contain stored data). In this regard, the memory device may remove invalid data (e.g., data that is no longer needed or valid)

To remove invalid data, the memory device may perform a garbage collection process. In the garbage collection process, the memory device relocates (e.g., copies to another block) the pages that include valid data. After relocating the valid data, the memory device erases the block.

While freeing space in the memory, garbage collection may result in inefficiencies, such as write amplification. More specifically, write amplification is dependent on the number of valid pages in a block, with more valid pages resulting in greater write amplification. In this regard, in order to reduce the write amplification, blocks with a higher number of invalid pages are selected for garbage collection. For example, a traditional “greedy” garbage collection algorithm may: (1) continuously sort blocks in the memory according to the number of invalid pages; and (2) select the blocks with the maximum number of invalid pages for garbage collection.

### BRIEF SUMMARY

According to one aspect, a method for a memory device is disclosed. The method includes: determining for a plurality of blocks in a memory of the memory device a respective block health indicator indicative of health of part or all of a respective block in the memory; determining to perform garbage collection; and in response to determining to perform garbage collection, selecting one or more blocks in the memory for garbage collection based at least in part on the respective block health indicators.

According to another aspect, a method for selecting one or more blocks in a memory for garbage collection is disclosed. The method includes: generating a ranking of a plurality of blocks based on a number of invalid pages and a block health indicator for a respective block; and selecting the one or more blocks for garbage collected based on the ranking.

According to yet another aspect, a memory device is disclosed. The memory device includes: a block health indicator module configured to determine health indicators for a plurality of blocks in a memory of the memory device; a ranking module configured to rank some or all of the plurality of the blocks according to a respective block's health indicator and to the respective block's amount of invalid data; a garbage collection trigger module configured to determine when to trigger selection of blocks for garbage collection; and a block selection module configured to, in response to the trigger, select one or more blocks for garbage collection according to the rank of some or all of the plurality of blocks.

Other features and advantages will become apparent upon review of the following drawings, detailed description and claims. Additionally, other embodiments are disclosed, and each of the embodiments can be used alone or together in combination. The embodiments will now be described with reference to the attached drawings.

### BRIEF DESCRIPTION OF THE DRAWINGS

The system may be better understood with reference to the following drawings and description. In the figures, like reference numerals designate corresponding parts throughout the different views.

FIG. 1A illustrates a host system connected with a memory device.

FIG. 1B illustrates another block diagram of the memory device controller.

FIG. 2A illustrates memory device controller chip, which is a first example of memory device controller depicted in FIG. 1A.

FIG. 2B illustrates memory device controller chip, which is a second example of memory device controller depicted in FIG. 1A.

FIG. 3 is an example one flash memory bank suitable as one of the non-volatile memory banks illustrated in FIG. 1A.

FIG. 4 is a representative circuit diagram of a memory cell array that may be used in the memory bank of FIG. 3.

FIG. 5 illustrates an example physical memory organization of the memory bank of FIG. 3.

FIG. 6 shows an expanded view of a portion of the physical memory of FIG. 5.

FIG. 7 illustrates a block diagram of the filled pool and the empty pool, and the arrangement of block references therein.

FIG. 8 illustrates one example of a flow diagram for determining which section(s) of memory to select for garbage collection.

FIG. 9 illustrates another example of a flow diagram for selecting the blocks in memory for garbage collection.

FIG. 10 illustrates yet another example of a flow diagram for selecting the blocks in memory for garbage collection.

### DETAILED DESCRIPTION

As discussed in the background, blocks are typically selected for garbage collection solely based on the number of invalid pages in a respective block. For example, the system controller in the memory device may continuously rank the blocks based on the number of invalid pages, and select for garbage collection the blocks with the maximum number of invalid pages (e.g., those blocks ranked highest in the number of invalid pages). This focus on the number of invalid pages does reduce the write amplification problem. However, solely focusing on the number of invalid pages is one-dimensional and limiting.

In one embodiment, sections of memory (such as blocks) may be selected for garbage collection based on one or more other criteria, such as one or more memory section health indicators (such as one or more block health indicators). Thus, the one or more block health indicators may be used to at least partly determine which blocks to select for garbage collection. In a first more specific embodiment, the blocks may be selected for garbage collection based on one or more block health indicators and the number of invalid pages. In a second more specific embodiment, the blocks may be selected for garbage collection based on one or more block health indicators irrespective of the number of invalid pages.

A memory section health indicator (such as a block health indicator) may be indicative of part or all of the health of the section of memory. In this regard, the section of memory, such as the block, may be characterized by a health indicator, which may comprise an indication of usability of the section of memory. More specifically, the health indicator may comprise the period (e.g., the number of cycles or time) until the section of memory is unusable. As discussed herein, the section of memory used for garbage collection is the block. In this regard, blocks and block health indicator(s) may be interchangeably used for memory section and memory section indicator(s), respectively.

There are various types of indicators of block health. One example of a block health indicator is the program/erase (P/E) cycles. A block may undergo cycles of being programmed and then being erased. Typically, a block may have a limited number of P/E cycles until the block fails (e.g., the bit error rate for data programmed in the block becomes too large to correct via ECC engine). This is because after repeated P/E cycles the block wears out (i.e., becomes less healthy), that is its physical characteristics gradually degrade, adversely affecting its reliability. Typically, the higher the number for P/E cycles associated with a respective block, the worse the health of the respective block. In this regard, the number of times that a respective block undergoes the P/E cycles may be an indicator of block health.

Another example of a block health indicator is the bit error rate (BER). One way to determine the BER is to fully decode data read from a respective block. More specifically, after programming data into a block, the data may be subsequently read. The read data may be sent to an error correction coding (ECC) engine, which may fully complete the decoding process and extract the bits in error, thereby calculating the number of bits in the read data that are in error (i.e., the BER). In the event that the BER exceeds the capability of the ECC engine to correct, the errors in the data in a respective block become uncorrectable. After which, the respective block is marked as unusable. Thus, the higher the BER associated with a respective block, the worse the block health. Another way to determine the BER is to partially decode data from a respective block. For example, the read data may be analyzed using a low-density parity-check (LDPC) decoder as a way to assess the BER without fully performing the decoding process. More specifically, certain weights used in the LDPC decoding process (e.g., syndrome weights) may be proportional to the BER, and may thus be indicative of the respective block's health.

Still another example of a block health indicator is the erase speed associated with a respective block. More specifically, the erase speed slows as the respective block ages. In this regard, a slower erase speed for a respective block is indicative of a less healthy block. Yet another example of a block health indicator is the program speed associated with a respective block. More specifically, the program speed increases as the respective block ages. In this regard, a higher program speed for a respective block is indicative of a less healthy block.

Yet another example of a block health indicator is the number of cells mistakenly programmed. As discussed above, prior to programming a block, the block is erased. After which the block may be programmed with data. The more worn-out a block, the more cells that are supposed to remain erased, but are mistakenly programmed when another part of the block is programmed. In this regard, the number of cells in a block mistakenly programmed may be an indicator of block health, with a higher number of cells mistakenly programmed indicative of a less healthy block.

The indicator of health may be for a respective section in memory. In one embodiment, the health indicator may be at the block level, hence may be termed a block health indicator (e.g., indicative of the health of part or all of a respective block). In an alternate embodiment, the health indicator may be at a different level, such as at the page level, and may be termed a page health indicator.

Further, the indicator may be based on part (or all) of the health associated with the respective section in memory. For example, the block health indicator may be based on the health of part (or all) of the block. In one embodiment, the block health indicator for a respective block may be based on one or more pages in the respective block (but fewer than all of the pages in the respective block). For example, a single page in a respective block may be read, and the BER associated with the single page may be determined. The BER for the single page may be used as the block health indicator for the respective block. As another example, a plurality of pages (but fewer than all) in the respective block may be read, and the BERs associated with the plurality of pages may be determined. The BERs for the plurality of pages may be averaged, with the average being used as the block health indicator for the respective block. In this regard, the health indicator of a sub-part of the respective block may be extrapolated to indicate the health of the entire respective block. In an alternate embodiment, the block health indicator for a respective block may be based on all of the pages in the respective block. For example, all of the pages in the respective block may be read, and the BERs associated with all of the pages may be determined. The BERs for all of pages may be averaged, with the average being used as the block health indicator for the respective block.

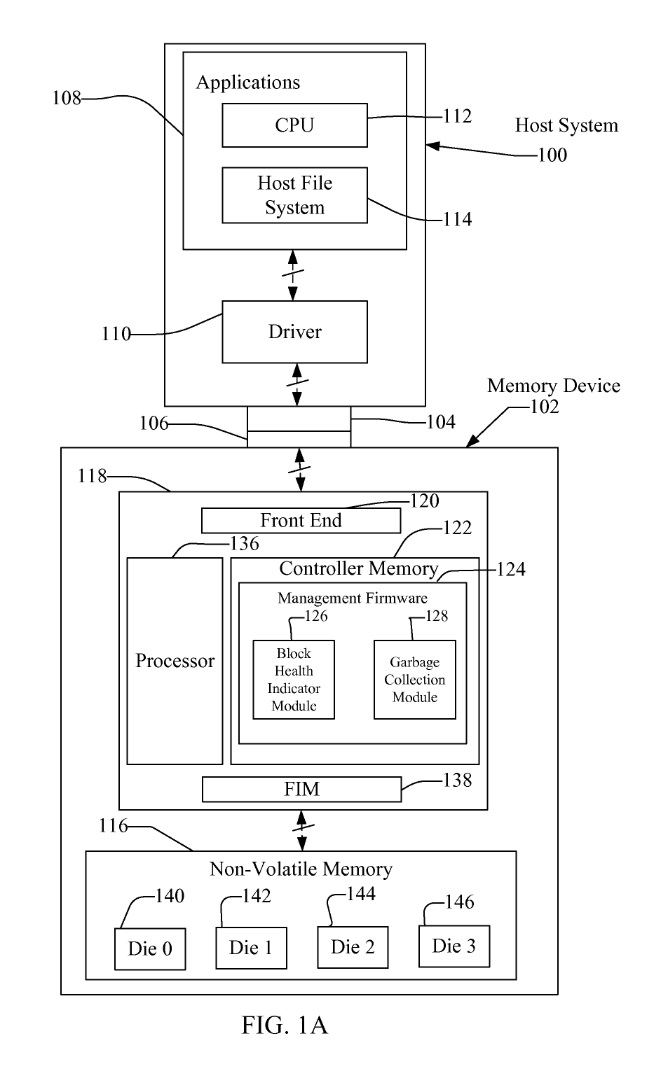

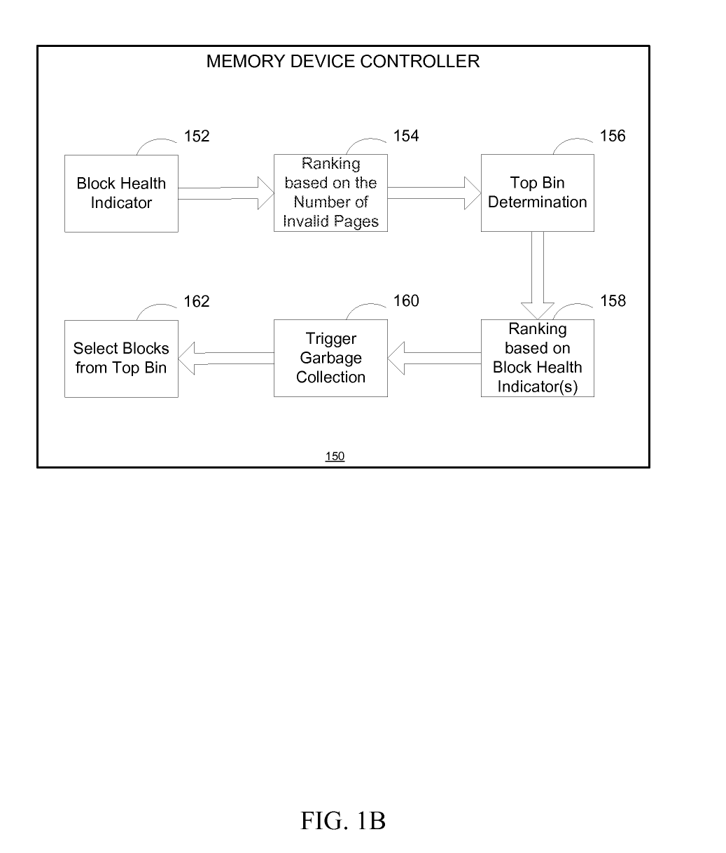

Referring to FIG. 1A, a host system 100 of FIG. 1A stores data into and retrieves data from a memory device 102. The memory device 102 may be memory embedded within the host, such as in the form of a solid state disk (SSD) drive installed in a personal computer. Alternatively, the memory device 102 may be in the form of a card that is removably connected to the host system 100 through mating parts 104 and 106 of a mechanical and electrical connector as illustrated in FIG. 1A. A memory configured for use as an internal or embedded SSD drive may look similar to the schematic of FIG. 1A, with the primary difference being the location of the memory device 102 internal to the host system 100. SSD drives may be in the form of discrete modules that are drop-in replacements for rotating magnetic disk drives.

The host system 100 of FIG. 1A may be viewed as having two major parts, insofar as the memory device 102 is concerned, made up of a combination of circuitry and software. They are an applications portion 108 and a driver portion 110 that interfaces with the memory device 102. In a personal computer, for example, the applications portion 110 can include a processor 112 running word processing, graphics, control or other popular application software, as well as the file system 114 for managing data on the host system 100. In a camera, cellular telephone or other host system that is primarily dedicated to performing a single set of functions, the applications portion 108 includes the software that operates the camera to take and store pictures, the cellular telephone to make and receive calls, and the like.

The memory device 102 of FIG. 1A may comprise a semiconductor memory device. Semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are exemplary, and memory elements may be otherwise configured.

The semiconductor memory elements located within and/or over a substrate may be arranged in two or three dimensions, such as a two dimensional memory structure or a three dimensional memory structure.

In a two dimensional memory structure, the semiconductor memory elements are arranged in a single plane or a single memory device level. Typically, in a two dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and word lines.

A three dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration, e.g., in an x-z plane, resulting in a three dimensional arrangement of memory elements with elements on multiple vertically stacked memory planes. Other configurations of memory elements in three dimensions can also constitute a three dimensional memory array.

By way of non-limiting example, in a three dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Then again, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this invention is not limited to the two dimensional and three dimensional exemplary structures described but cover all relevant memory structures within the spirit and scope of the invention as described herein and as understood by one of skill in the art.

Referring back to FIG. 1A, the memory device 102 may include non-volatile memory, such as memory 116, and a system controller 118 that both interfaces with the host system 100 to which the memory device 102 is connected for passing data back and forth and controls the memory 116. Other types of non-volatile memory are contemplated, such as resistive memory, which may be composed of a plurality of resistive memory cells, and ferroelectric memory.

When communicating with the memory device 102, the host system 100 may send logical addresses of data, such as in the form of a range of logical block addresses (LBAs). The system controller 118 may then convert the LBAs, in one or more steps, to the actual physical addresses on the memory 116. The system controller 118 may perform a logical address-to-actual physical address conversion in order to map to the actual physical addresses. For example, the LBAs from the host system 100 may be mapped to memory device internal logical addresses, and the memory device internal logical addresses are mapped to the actual physical addresses. As another example, the LBAs from the host system 100 may be mapped directly to the actual physical addresses.

FIG. 1A illustrates that the memory 116 includes four memory die 140, 142, 144, 146. The number of memory die is merely for illustrative purposes. Other numbers of memory die are contemplated.

The system controller 118 may perform a variety of functions. FIG. 1A illustrates the various functions of the system controller 118, including a front end 120, a processor 136, a controller memory 122, and one or more flash interface modules (FIMs) 138. The front end 120 interfaces with the host system 100 and one or more flash interface modules (FIMs) 138 provide a communication interface between the system controller 118 with the memory 116. The controller memory 122 may store controller firmware logic for coordinating operation of the memory 116 and for internal memory management operations. As one example, the controller firmware, when executed by the processor 136, may perform a multitude of operations, such as managing host communications, mapping host requests to NAND addresses, executing NAND operations, reporting completion status to host, etc. As another example, the controller firmware may include management firmware 124 that, when executed, includes the functionality discussed in more detail below. Examples of the firmware may include block health indicator module 126 and garbage collection module 128.

As discussed above, block health indicator module 126 and garbage collection module 128 are included in firmware. Any one, any combination or all of block health indicator module 126 and garbage collection module 128 can be implemented as software, hardware, or a combination of hardware and software inside system controller 118 or can be implemented as a component outside of the system controller 118. Further, block health indicator module 126 and garbage collection module 128 are illustrated in FIG. 1A as separate entities. Alternatively, any combination or all of block health indicator module 126 and garbage collection module 128 may be included in a single software program or in a single hardware implementation. The functions of the system controller 118 as depicted in FIG. 1A are merely for illustration purposes.

FIG. 1B illustrates another block diagram of the memory device controller 150. More specifically, FIG. 1B illustrates an embodiment in which ranking is first performed based on the number of invalid pages, and thereafter, ranked based on the block health indicator(s). More specifically, the block health indicator 152 is configured to determine the block health indicator for a respective block. Further, the ranking based on the number of invalid pages module 154 is configured to rank some or all of the blocks in the memory based on the number of invalid pages in the block. Alternatively, the ranking may be based on the number of valid pages in the block. After ranking based on the number of invalid pages, the top bin determination module 156 is configured to select a subset of the blocks ranked based on the number of invalid pages. The subset may comprise a top bin, or top set, of blocks that are the most likely candidates for garbage collection. As discussed in more detail below, the top bin may be determined in one of several ways. In one embodiment, the top bin may be determined using a predetermined number of invalid pages. More specifically, all of the blocks that have a number of invalid pages greater than or equal to the predetermined number of invalid pages may be deemed to be in the top bin. In an alternate embodiment, the top bin may be determined using a predetermined number of blocks. For example, the predetermined number of blocks may equal 10. In this regard, the top 10 ranked blocks (i.e., the 10 blocks with the most number of invalid pages) may be designated as being in the top bin. In still an alternate embodiment, the top bin may be determined using a combination of the predetermined number of invalid pages and the predetermined number of blocks. For example, initially, the predetermined number of invalid pages may be used as the determinator for top bin designation. In the event that the number of blocks designated in the top bin is less than a predetermined number (e.g., fewer than 10, fewer than 5, or no blocks), then the predetermined number of blocks may be used as the determinator for top bin designation.

The ranking based on block health indicator(s) module 158 may rank some or all of the blocks in the memory. In one embodiment, the ranking based on block health indicator(s) module 158 may rank the blocks as designated in the top bin by the top bin determination module 156. In one embodiment, the ranking may be based on a single block health indicator. For example, the blocks designated in the top bin may be rearranged, reorganized, or re-tagged based on the single block health indicator. In the specific example of the block health indicator being the BER, the blocks designated in the top bin may be reorganized, rearranged, or re-tagged based on a respective block's BER such that the blocks at the top of the top bin have the lowest BER amongst all of the blocks as designated in the top bin.

In an alternate embodiment, the ranking may be based on multiple block health indicators. In one embodiment, the ranking based on multiple block health indicators may be performed in serial fashion, with a first block health indicator being used to generate a first ranking, and then a second block health indicator being used to re-rank the first ranking. In an alternate embodiment, the ranking based on multiple block health indicators may be performed simultaneously. For example, some or all of the block health indicators may be weighted to generate an overall rank. In this regard, the blocks ranked highest in the top bin (and first to be selected for garbage collection) may be considered the healthiest.

The trigger garbage collection module 160 may be configured to determine whether to trigger garbage collection. Garbage collection may be triggered in one of several ways. In one way, in response to determining that the number of free blocks in the memory is below a predetermined number, garbage collection may be triggered. In response to the trigger for garbage collection, the select blocks from top bin module 162 may be executed. The select blocks from top bin module 162 may select one or more blocks from the top bin, with the top ranked blocks in the top bin being considered the healthiest. In one embodiment, a predetermined number of blocks may be selected. In an alternative embodiment, a variable number of blocks may be selected from the top bin. For example, the number of blocks selected from the top bin for garbage collection may be dependent on the number of free blocks available in the memory.

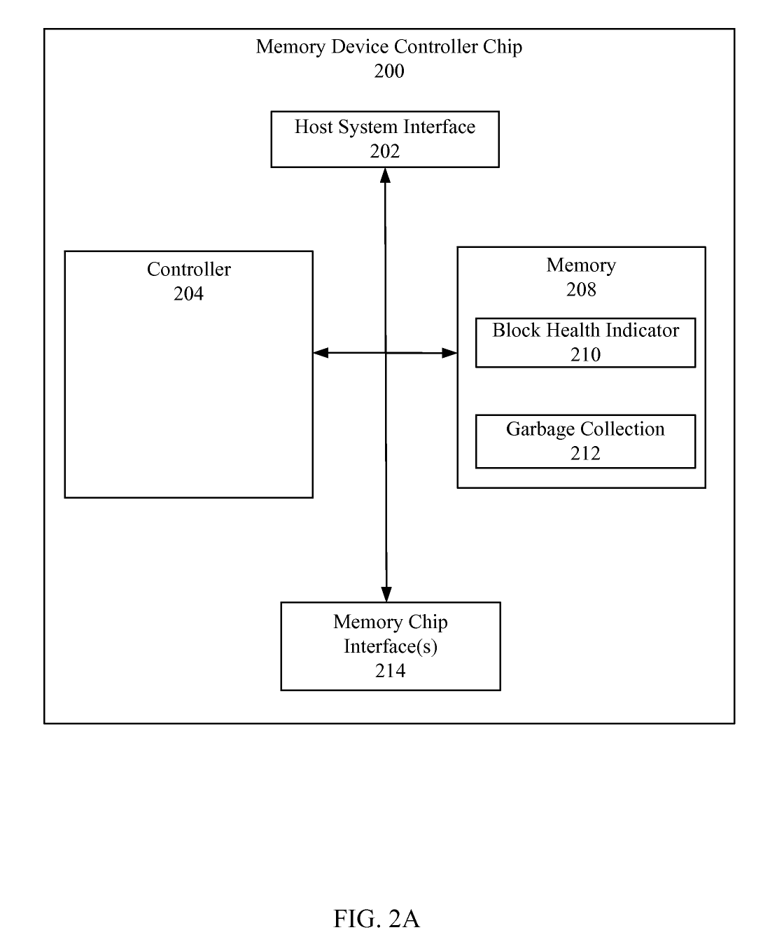

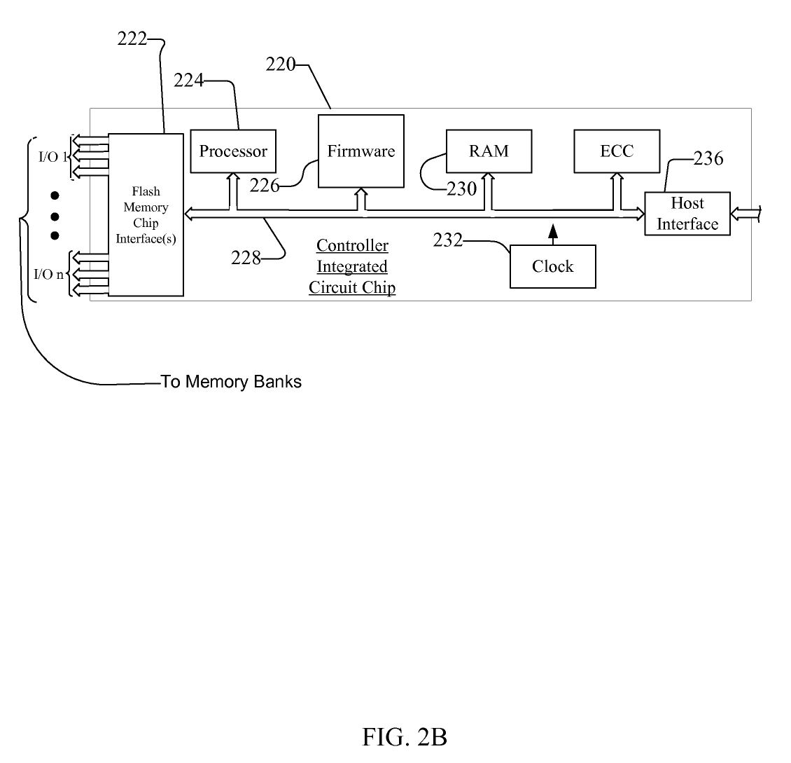

FIG. 2A illustrates memory device controller chip 200, which is an example of memory device controller 118 depicted in FIG. 1A. As illustrated in FIG. 2A, memory device controller chip 200 includes host system interface 202, which may comprise circuitry and/or software in order to communicate with the host system 100. Alternatively, host system interface 202 may be external to memory device controller chip 200. Memory device controller chip 200 further includes controller 204, memory 208, and memory chip interface(s) 214. Memory 208 may include block health indicator 210 and garbage collection 212. Block health indicator 210 may comprise software that is executable by controller 204 to determine the health of a block, as discussed above. Garbage collection 212 may comprise software that is executable by controller 204 to perform garbage collection, as discussed above. Memory chip interface 214 may comprise one or more communication lines configured to communicate with one or more memory chips.

FIG. 2B illustrates memory device controller chip 220, which is a second example of memory device controller 118 depicted in FIG. 1A. The memory device controller chip 220 may be implemented on a single integrated circuit chip 220, such as an application specific integrated circuit (ASIC), as shown in FIG. 2B. Further, the various functions performed by the memory device controller chip 220 may be performed by a single device, or may be performed by multiple devices, such as shown in FIG. 2B. More specifically, the memory device controller chip 220 may be segmented into the different devices illustrated in FIG. 2B, such as flash memory interface(s) 222, processor 224, RAM 223, ECC 234, host interface 236, and clock 232. FIG. 2B is merely for illustration purposes.

The processor 224 of the memory device controller chip 220 may be configured as a multi-thread processor capable of communicating separately with a respective memory chip via one or more flash memory interface(s) 222. The flash memory interface(s) 222 may have I/O ports for each of the respective memory chips in the memory 116. The memory device controller chip 220 may include an internal clock 232. The processor 224 may communicate with an error correction code (ECC) module 234 (discussed in more detail below), a RAM buffer 230, a host interface 236, and firmware 226 (which may include boot code ROM) via an internal data bus 228.

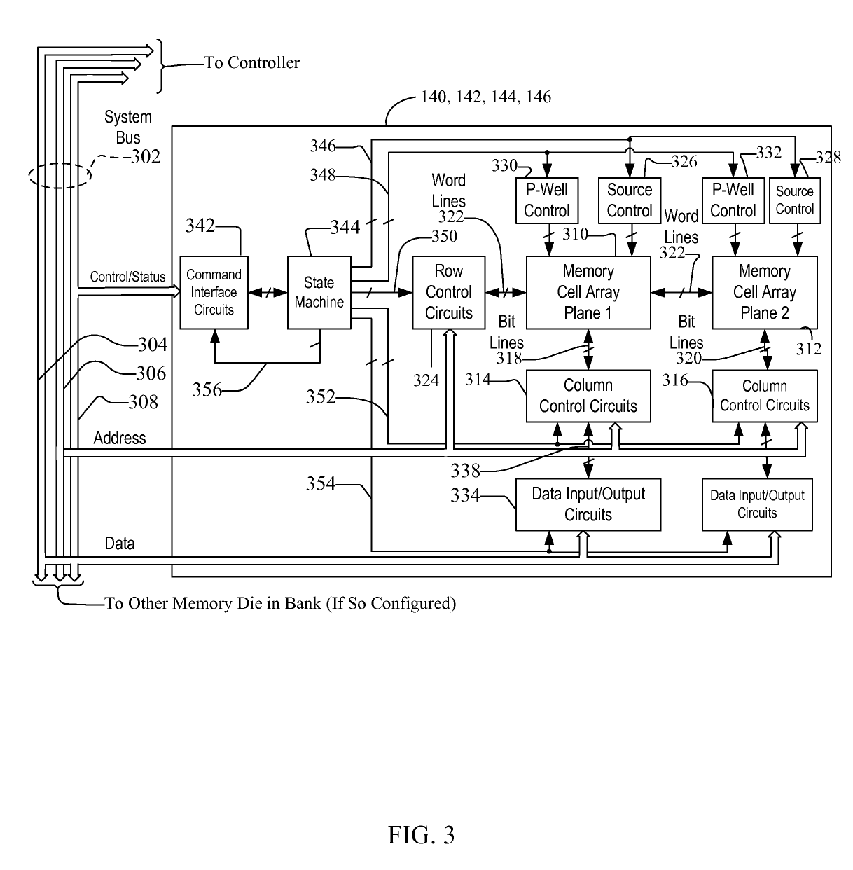

Each die 140, 142, 144, 146 in the memory 116 may contain an array of memory cells organized into multiple planes. FIG. 3 shows one of such planes 310 and 312 for simplicity but a greater number of planes, such as four or eight planes, may instead be used. Alternatively, the memory cell array of a memory bank may not be divided into planes. When so divided, however, each plane has its own column control circuits 314 and 316 that are operable independently of each other. The circuits 314 and 316 receive addresses of their respective memory cell array from the address portion 306 of the system bus 302, and decode them to address a specific one or more of respective bit lines 318 and 320. The word lines 322 are addressed through row control circuits 324 in response to addresses received on the address bus 19. Source voltage control circuits 326 and 328 are also connected with the respective planes, as are p-well voltage control circuits 330 and 332. If the bank 300 is in the form of a memory chip with a single array of memory cells, and if two or more such chips exist in the system, data are transferred into and out of the planes 310 and 312 through respective data input/output circuits 334 and 336 that are connected with the data portion 304 of the system bus 302. The circuits 334 and 336 provide for both programming data into the memory cells and for reading data from the memory cells of their respective planes, through lines 338 and 340 connected to the planes through respective column control circuits 314 and 316.

Although the processor 206 in the system controller 118 controls the operation of the memory chips in each bank 120 to program data, read data, erase and attend to various housekeeping matters, each memory chip also contains some controlling circuitry that executes commands from the controller 118 to perform such functions. Interface circuits 342 are connected to the control and status portion 308 of the system bus 302. Commands from the controller 118 are provided to a state machine 344 that then provides specific control of other circuits in order to execute these commands. Control lines 346-354 connect the state machine 344 with these other circuits as shown in FIG. 3. Status information from the state machine 344 is communicated over lines 356 to the interface 342 for transmission to the controller 118 over the bus portion 308.

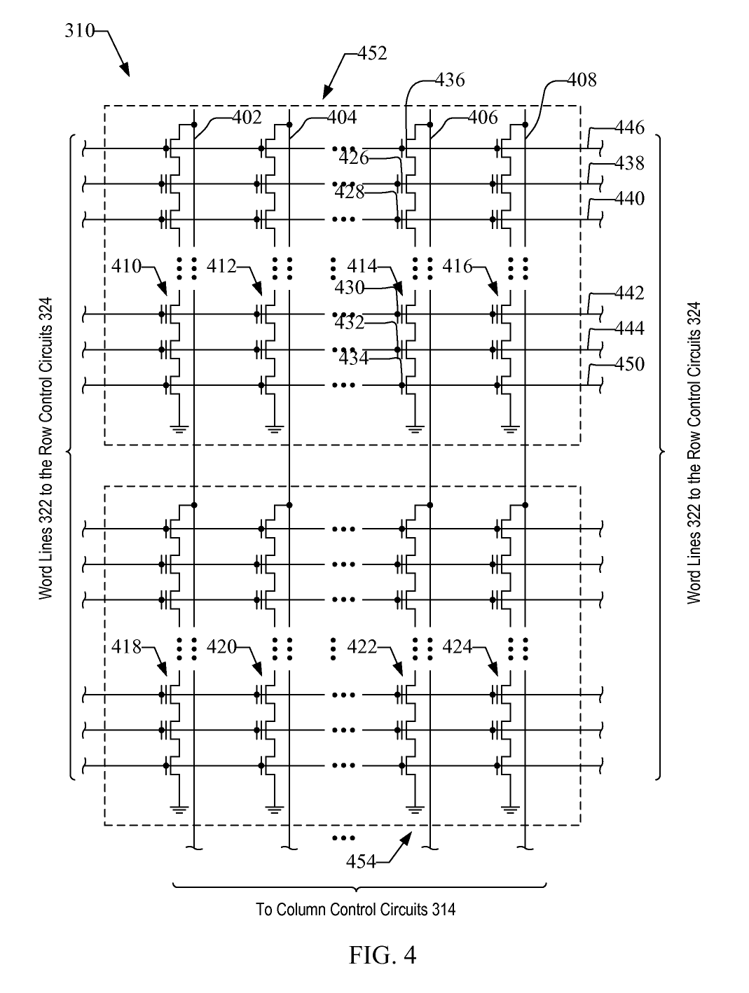

A NAND architecture of the memory cell arrays 310 and 312 is discussed below, although other architectures, such as NOR, can be used instead. An example NAND array is illustrated by the circuit diagram of FIG. 4, which is a portion of the memory cell array 310 of the memory bank 300 of FIG. 3. A large number of global bit lines are provided, only four such lines 402-408 being shown in FIG. 4 for simplicity of explanation. A number of series connected memory cell strings 410-424 are connected between one of these bit lines and a reference potential. Using the memory cell string 414 as representative, a plurality of charge storage memory cells 426-432 are connected in series with select transistors 434 and 436 at either end of the string. When the select transistors of a string are rendered conductive, the string is connected between its bit line and the reference potential. One memory cell within that string is then programmed or read at a time.

Word lines 438-444 of FIG. 4 individually extend across the charge storage element of one memory cell in each of a number of strings of memory cells, and gates 446 and 450 control the states of the select transistors at each end of the strings. The memory cell strings that share common word and control gate lines 438-450 are made to form a block 452 of memory cells that are erased together. This block of cells contains the minimum number of cells that are physically erasable at one time. One row of memory cells, those along one of the word lines 438-444, are programmed at a time. Typically, the rows of a NAND array are programmed in a prescribed order, in this case beginning with the row along the word line 444 closest to the end of the strings connected to ground or another common potential. The row of memory cells along the word line 442 is programmed next, and so on, throughout the block 452. The row along the word line 438 is programmed last.

A second block 454 is similar, its strings of memory cells being connected to the same global bit lines as the strings in the first block 452 but having a different set of word and control gate lines. The word and control gate lines are driven to their proper operating voltages by the row control circuits 324. If there is more than one plane in the system, such as planes 1 and 2 of FIG. 3, one memory architecture uses common word lines extending between them. There can alternatively be more than two planes that share common word lines. In other memory architectures, the word lines of individual planes are separately driven.

The memory cells may be operated to store two levels of charge so that a single bit of data is stored in each cell. This is typically referred to as a binary or single level cell (SLC) memory. Alternatively, the memory cells may be operated to store more than two detectable levels of charge in each charge storage element or region, thereby to store more than one bit of data in each. This latter configuration is referred to as multi-level cell (MLC) memory. Both types of memory cells may be used in a memory, for example binary flash memory may be used for caching data and MLC memory may be used for longer term storage. The charge storage elements of the memory cells are most commonly conductive floating gates but may alternatively be non-conductive dielectric charge trapping material.

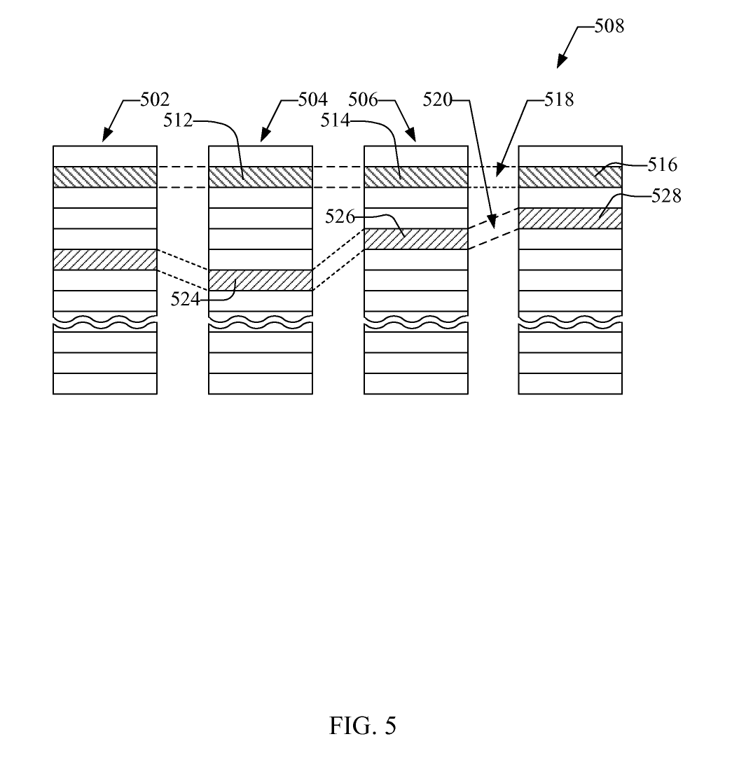

FIG. 5 conceptually illustrates a multiple plane arrangement showing four planes 502-508 of memory cells. These planes 502-508 may be on a single die, on two die (two of the planes on each die) or on four separate die. Of course, other numbers of planes, such as 1, 2, 8, 16 or more may exist in each die of a system. The planes are individually divided into blocks of memory cells shown in FIG. 5 by rectangles, such as blocks 510, 512, 514 and 516, located in respective planes 502-508. There can be dozens or hundreds of blocks in each plane.

As mentioned above, a block of memory cells is the unit of erase, the smallest number of memory cells that are physically erasable together. For increased parallelism, however, the blocks are operated in larger metablock units. One block from each plane is logically linked together to form a metablock. The four blocks 510-516 are shown to form one metablock 518. All of the cells within a metablock are typically erased together. The blocks used to form a metablock need not be restricted to the same relative locations within their respective planes, as is shown in a second metablock 520 made up of blocks 522-528. Although it is usually preferable to extend the metablocks across all of the planes, for high system performance, the memory device can be operated with the ability to dynamically form metablocks of any or all of one, two or three blocks in different planes. This allows the size of the metablock to be more closely matched with the amount of data available for storage in one programming operation.

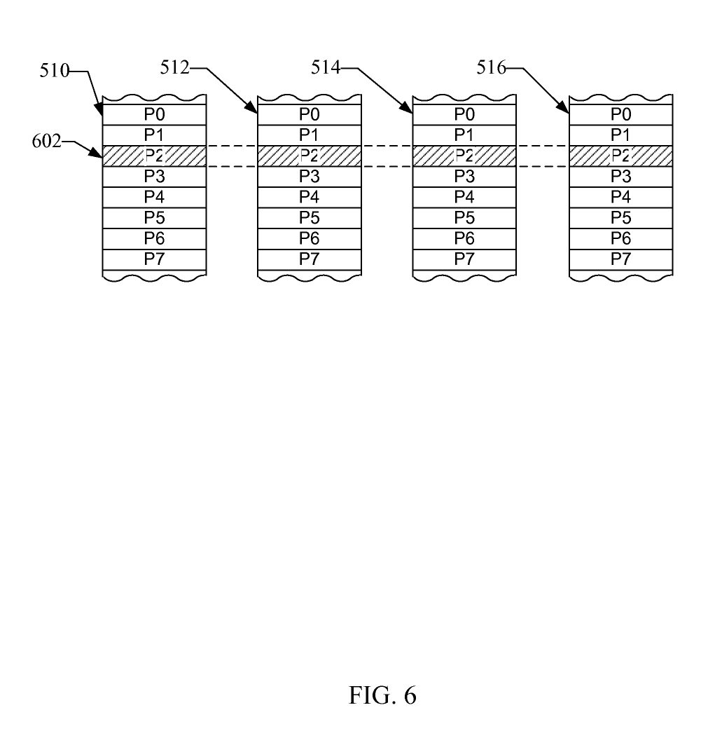

The individual blocks are in turn divided for operational purposes into pages of memory cells, as illustrated in FIG. 6. The memory cells of each of the blocks 510-516, for example, are each divided into eight pages P0-P7. Alternatively, there may be 32, 64 or more pages of memory cells within each block. The page is the unit of data programming and reading within a block, containing the minimum amount of data that are programmed or read at one time. In the NAND architecture of FIG. 3, a page is formed of memory cells along a word line within a block. However, in order to increase the memory device operational parallelism, such pages within two or more blocks may be logically linked into metapages. A metapage 602 is illustrated in FIG. 6, being formed of one physical page from each of the four blocks 510-516. The metapage 602, for example, includes the page P2 in each of the four blocks but the pages of a metapage need not necessarily have the same relative position within each of the blocks. Within a die, a metapage is the maximum unit of programming.

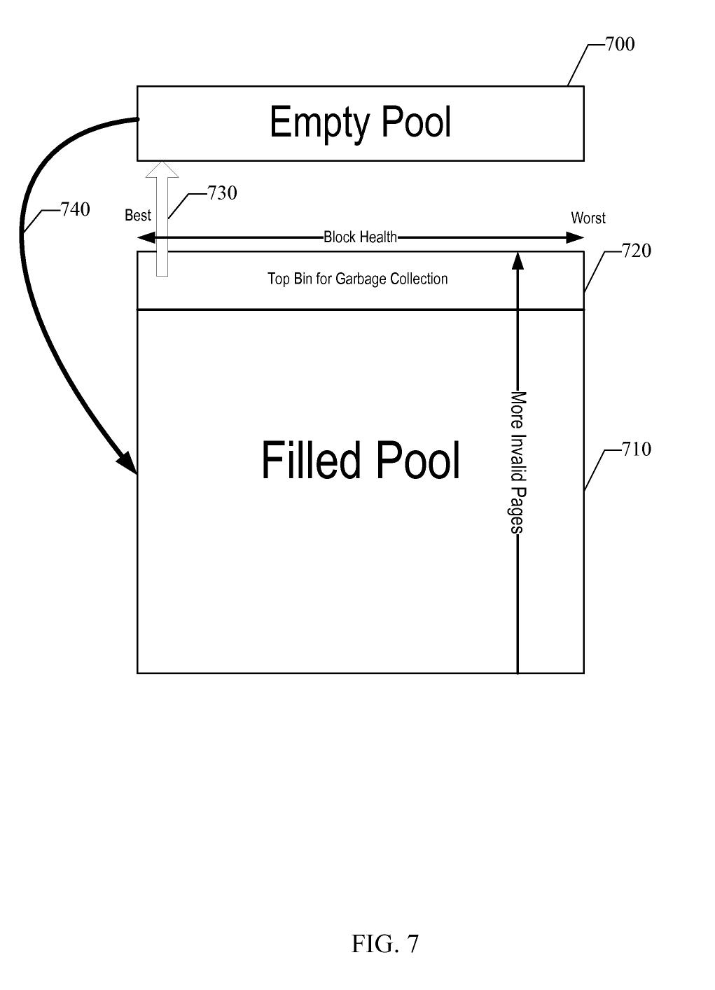

FIG. 7 illustrates a block diagram of the filled pool 710 and the empty pool 700, and the arrangement of block references therein. The filled pool 710 includes references to blocks (e.g., an LBA designation, physical address designation, or the like) that are designated as filled, and therefore are candidates for garbage collection. Likewise, the empty pool 700 includes references to blocks that are designated as filled, and therefore are candidates for writing data.

As discussed above, the references to the filled blocks in the filled pool 710 may be arranged in one of several ways. In one way, the references to the filled blocks may be arranged according to the number of invalid pages in a respective block. As illustrated in FIG. 7, the references in the filled pool 710 are arranged such that blocks with fewer invalid pages are listed toward the bottom of filled pool 710, and blocks with greater invalid pages are listed toward the top of filled pool 710. Further, filled pool 710 may include a top bin for garbage collection 720. As discussed above, the top bin for garbage collection 720 may comprises references to the blocks that meet certain criteria in terms of the number of invalid pages. As one example, a block that includes more than a predetermined number of invalid pages may have its associated reference included in the top bin for garbage collection 720. As another example, a block that has the highest number of invalid pages (e.g., the top 10 blocks with the most number of invalid pages) may have its associated reference included in the top bin for garbage collection 720.

Further, within the top bin for garbage collection 720, the references may further be ranked (or sorted) based on block health. As illustrated in FIG. 7, the blocks that are healthiest have their associated references sorted toward the left of top bin for garbage collection 720, and the blocks that are unhealthiest have their associated references sorted toward the right of top bin for garbage collection 720. When a garbage collection process is triggered, the blocks whose references are located toward the left of top bin for garbage collection 720 (i.e., the healthiest blocks with the most invalid pages) are selected for garbage collection, as illustrated in arrow 730. FIG. 7 further illustrates that blocks from the empty pool may have data stored therein and returned to the filled pool, such as illustrated by arrow 740.

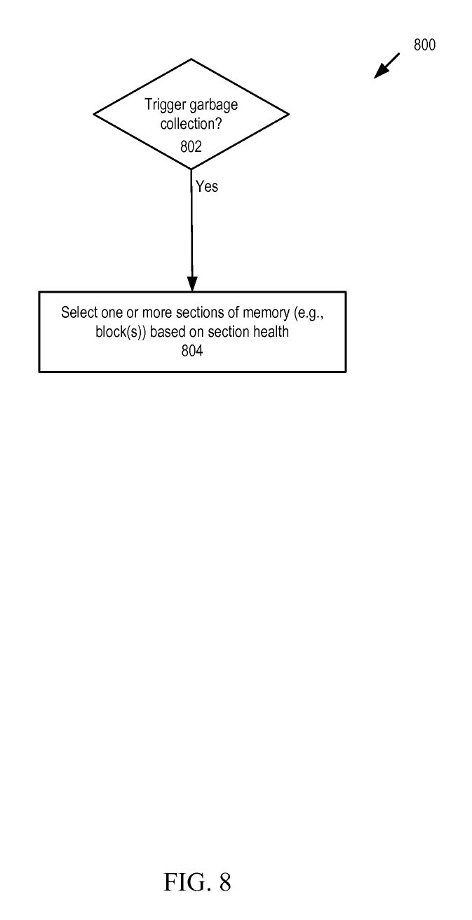

FIG. 8 illustrates one example of a flow diagram 800 for determining which section(s) of memory to select for garbage collection. At 802, it is determined whether to trigger garbage collection. In response to determining to trigger garbage collection, at 804, one or more sections of memory (such as one or more blocks) are selected based on the section health. As discussed above, the section health may comprise one or more block health indicators. Further, the block health indicator(s) may be used with other criteria, such as the number of invalid data in the section of memory (e.g., the number of invalid pages), to select the sections of memory for garbage collection.

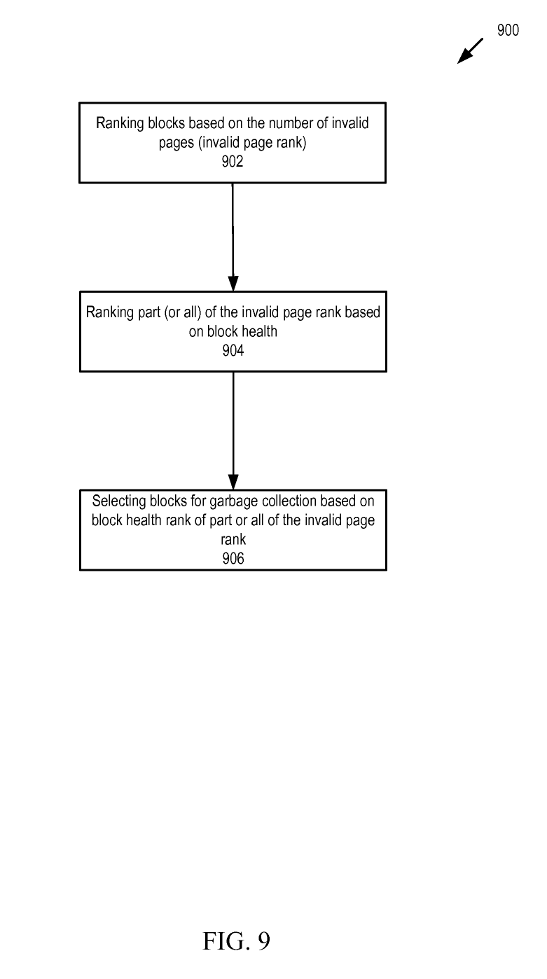

FIG. 9 illustrates another example of a flow diagram 900 for selecting the blocks in memory for garbage collection. As discussed above, the blocks may be ranked multiple times based on multiple criteria. FIG. 9 illustrates ranking first based on the number of invalid pages in the block, and thereafter ranking based on block health. At 902, the blocks are ranked based on the number of invalid pages in order to generate an invalid page rank. The invalid page rank may be represented in one of several ways. In one way, the invalid page rank may comprise a list of references to blocks (such as to LBA or physical addresses that are indicative of a specific block), with the invalid page list being organized according to the number of invalid pages (e.g., the blocks with the highest number of invalid pages are at the top of the invalid page list and the blocks with the lowest number of invalid pages are at the bottom of the invalid page list).

At 904, part or all of the invalid page rank is ranked based on the block health. For example, part or all of the invalid page list may be reordered or re-ranked based on the block health. More specifically, a part of the invalid page list, such as the blocks in the invalid page list with the highest number of invalid pages (e.g., the most invalid page list), may be reordered based on the block health, with the healthiest blocks being at the top of the re-ranked most invalid page list and the unhealthiest blocks being at the bottom of the re-ranked most invalid page list.

At 906, blocks are selected for garbage collection based on the block health rank of part or all of the invalid page rank. For example, the re-ranked most invalid page list may be accessed to determine which blocks to select. More specifically, the block(s) on the top of the re-ranked most invalid page list may be selected since these blocks have the most invalid number of pages and are deemed to be the healthiest.

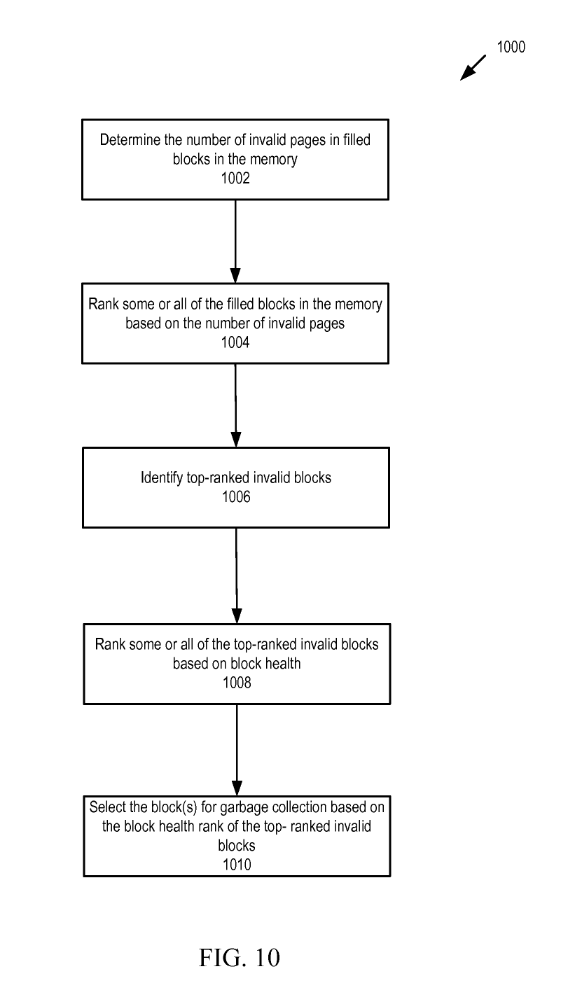

FIG. 10 illustrates yet another example of a flow diagram 1000 for selecting the blocks in memory for garbage collection. At 1002, the number of invalid pages in the filled blocks in memory is determined. At 1004, some or all of the filled blocks in the memory are ranked based on the number of invalid pages. For example, the filled blocks may be ranked in filled pool 710 in FIG. 7 according to the number of invalid pages.

At 1006, the top-ranked invalid blocks are identified. For example, as illustrated in FIG. 7, the blocks in the top bin may be identified. At 1008, some or all of the top-ranked invalid blocks are ranked based on block health. For example, the blocks referenced in the top bin may be reorganized so that the healthiest blocks are toward the left (e.g., at the top of the top bin). At 1010, the block(s) are selected for garbage collection base on the block health rank of the top-ranked invalid blocks. For example, the blocks at the top of the top bin may be selected for garbage collection.

Accordingly, the methods and systems discussed herein may be realized in hardware, software, or a combination of hardware and software. The method and system may be realized in a centralized fashion in at least one electronic device (such as illustrated in memory device 102 in FIG. 1A) or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein. Such a programmed computer may be considered a special-purpose computer.

The method and system may also be implemented using a computer-readable media. For example, management firmware 124 may be implemented using computer-readable media to implement the functionality described herein, such as discussed in FIGS. 8-10. A “computer-readable medium,” “computer-readable storage medium,” “machine readable medium,” “propagated-signal medium,” or “signal-bearing medium” may include any tangible device that has, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. The computer-readable medium can be a single medium or multiple media. Accordingly, the disclosure may be considered to include any one or more of a computer-readable medium or a distribution medium and other equivalents and successor media, in which data or instructions can be stored. For example, the processor 224 may access instructions stored in memory, such as RAM 230, in order to provide the functionality herein. As another example, the flash memory interface(s) may be configured to implement the functionality described herein. In either example, the system controller 118 may include a device that is configured to perform the functionality described herein.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present embodiments are to be determined by the broadest permissible interpretation of the following claims and their equivalents, and shall not be restricted or limited by the foregoing detailed description. While various embodiments have been described, it will be apparent to those of ordinary skill in the art that many more embodiments and implementations are possible within the scope of the above detailed description. Accordingly, the embodiments are not to be restricted except in light of the attached claims and their equivalents.

What is claimed is:

1. A method comprising:
determining for a plurality of blocks in a memory a respective block health indicator indicative of health of part or all of a respective block in the memory;
determining to perform garbage collection; and
in response to determining to perform garbage collection, selecting one or more blocks in the memory for garbage collection based at least in part on the respective block health indicators.

2. The method of claim 1, wherein the respective block health indicator comprises a number of program/erase (POE) cycles for the respective block.

3. The method of claim 1, wherein selecting the one or more blocks for garbage collection is based on the respective block health indicator and a number of invalid pages in the respective block.

4. The method of claim 3, wherein selecting the one or more blocks for garbage collection based on the respective block health indicator and a number of invalid pages in the respective block comprises:
ranking some or all of the plurality of blocks based on the number of invalid pages; and
selecting, based on the ranked some or all of the plurality of blocks, a subset of blocks for garbage collection based on the block health indicator indicating healthiest blocks.

5. The method of claim 4, wherein ranking some or all the plurality of blocks based on the number of invalid pages comprises identifying a set of blocks with a highest number of invalid pages.

6. The method of claim 5, wherein identifying the set of blocks with the highest number of invalid pages comprises: identifying blocks that have a number of invalid pages greater than a predetermined highest number of invalid pages.

7. The method of claim 5, wherein identifying the set of blocks with the highest number of invalid pages comprises identifying a predetermined number of blocks that have the highest number of invalid pages.

8. A method of selecting one or more blocks in a memory for garbage collection, the method comprising:
generating a ranking of a plurality of blocks based on a number of invalid pages and a block health indicator for a respective block; and
selecting the one or more blocks for garbage collected based on the ranking.

9. The method of claim 8, wherein generating a ranking of a plurality of blocks based on number of invalid pages and block health for a respective block comprises;
ranking the plurality of blocks based on the number of invalid pages; and
ranking at least a part of the ranked plurality of blocks based on the block health.

10. The method of claim 9, wherein ranking the plurality of blocks based on the number of invalid pages comprises selecting a subset of the plurality of blocks with the most invalid pages.

11. The method of claim 10, wherein selecting the subset of the plurality of blocks with the most invalid pages comprises selecting the blocks that have more than a predetermined number of invalid pages.

12. The method of claim 10, wherein selecting the subset of the plurality of blocks with the most invalid pages comprises selecting a predetermined number of blocks that have the most invalid pages.

13. A memory device comprising:
a block health indicator module configured to determine health indicators for a plurality of blocks in a memory of the memory device;
a ranking module configured to rank some or all of the plurality of the blocks according to a respective block's health indicator and the respective block's amount of invalid data;
a garbage collection trigger module configured to determine when to trigger selection of blocks for garbage collection; and
a block selection module configured to, in response to the trigger, select one or more blocks for garbage collection according to the rank of some or all of the plurality of blocks.

14. The memory device of claim 13, wherein the amount of invalid data comprises a number of invalid pages within the respective block.

15. The memory device of claim 13, wherein the ranking module is configured to first rank the some or all of the plurality of the blocks according to the amount of invalid data, and thereafter rank according to the health indicators.

16. The memory device of claim 13, wherein the health indicator is selected from the group consisting of: program/erase cycles, erase speed, and program speed.

17. The memory device of claim 13, wherein the ranking module is first configured to rank the some or all of the plurality of the blocks according to the respective block's amount of invalid data and then rank according to the respective block's health indicator.

18. The memory device of claim 17, wherein the ranking module is configured to rank the some or all the plurality of blocks based on the number of invalid pages by identifying a set of blocks with a highest number of invalid pages.

19. The memory device of claim 18, wherein the ranking module is configured to identify the set of blocks with the highest number of invalid pages by identifying blocks that have a number of invalid pages greater than a predetermined highest number of invalid pages.

20. The memory device of claim 18, wherein the ranking module is configured to identify the set of blocks with the highest number of invalid pages by identifying a predetermined number of blocks that have the highest number of invalid pages.

21. The memory device of claim 18, wherein the ranking module is configured to rank the set of blocks with the highest number of invalid pages according to the health indicators.

22. The memory device of claim 21, wherein the block selection module is configured to select the one or more blocks for garbage collection according to the ranked set of blocks with the highest number of invalid pages.

23. The memory device of claim 13, wherein the block health indicator module is configured to determine the health indicator for a plurality of filled blocks;
wherein the ranking module is configured to rank some or all of the plurality of the filled blocks according to a respective block's health indicator and to the respective block's amount of invalid data; and
wherein the block selection module is configured to select one or more filled blocks for garbage collection according to the rank of some or all of the plurality of filled blocks.
